(19) United States
(12) Patent Application Publication
(10) Pub. No.: US 2026/0274173 A1
(43) Pub. Date: Sep. 17, 2026

(54) SENSOR BRACKET AND SENSOR ATTACHMENT METHOD

(71) Applicant: TOYOTA JIDOSHA KABUSHIKI KAISHA, Aichi-ken (JP)

(72) Inventor: Yusuke KOJIMA, Komaki-shi (JP)

(21) Appl. No.: 19/372,275

(22) Filed: Oct. 29, 2025

(30) Foreign Application Priority Data
Dec. 16, 2024 (JP) 2024-220374

(51) Int. Cl. B60R 11/02; B60R 11/00; G01S 7/02

(52) U.S. Cl. CPC B60R 11/02; G01S 7/027; B60R 2011/004

(57) ABSTRACT

The sensor bracket is a resin member in which the sensor fixing portion, the base portion, and the integral hinge portion are integrally molded. When the sensor fixing portion rotates around the integral hinge portion, the sensor is accommodated in the base portion, and the engaging claw engages with the engaging hole to assemble the sensor fixing portion to the base portion. The sensor bracket is disposed between the peripheral edge of the engagement hole of the base portion and the engagement arm and includes a rib plate whose thickness is adjustable.

### CROSS REFERENCE TO RELATED APPLICATION

This application claims priority to Japanese Patent Application No. 2024-220374 filed on Dec. 16, 2024, which is incorporated herein by reference in its entirety including the specification, claims, drawings, and abstract.

### TECHNICAL FIELD

The present disclosure relates to the structure of a sensor bracket and a method of attaching a sensor to a vehicle.

### BACKGROUND

In recent years, a sensor for detecting the behavior of a user has been installed in a vehicle. For example, a vehicle equipped with a kick sensor that detects that a user protrudes his or her foot to the lower side of a rear portion of the vehicle is used. In this vehicle, when the user protrudes his or her foot below the back door, the kick sensor detects this, and the back door automatically opens (see, e.g., JP2019-127804A).

### SUMMARY

Such a sensor needs to detect the position of a hand or a foot of a user, but a detection range of the sensor may change depending on a variation in dimensions of each part of the vehicle. On the other hand, although the detection range of the sensor cannot be confirmed when the attachment of the sensor is not completed, it is difficult to adjust the detection range of the sensor after the attachment of the sensor is completed.

Accordingly, an object of the present disclosure is to provide a sensor bracket capable of adjusting the detection range of a sensor after the sensor is attached.

A sensor bracket according to an embodiment of the present disclosure includes: a sensor fixing portion to which a sensor is fixed; a base portion capable of internally housing the sensor; and an integral hinge portion that connects the base portion and the sensor fixing portion and enables rotation of the sensor fixing portion with respect to the base portion. The sensor fixing portion includes, at a tip end thereof, an engagement claw. The base portion includes an engagement hole in which the engagement claw is engaged. The sensor fixing portion, the base portion, and the integral hinge portion are integrally formed by molding resin. When the sensor fixing portion rotates around the integral hinge portion, the sensor is housed within the base portion, and the engagement claw is engaged in the engagement hole, to mount the sensor fixing portion to the base portion. Aa rib plate is disposed between a circumferential edge of the engagement hole of the base portion and the engagement claw, the rib plate having an adjustable thickness.

According to this configuration, the assembly angle of the sensor fixing portion with respect to the base portion can be adjusted by adjusting the thickness of the rib plate. Thus, the detection range of the sensor can be adjusted by adjusting the detection direction of the sensor fixed to the sensor fixing portion even after the sensor is attached to the body.

In the sensor bracket according to the present disclosure, the sensor may be attached to the sensor fixing portion so as to have a detection direction orthogonal to an extending direction of the integral hinge portion.

Thus, by adjusting the rib thickness, the detection angle of the sensor with respect to the ground can be adjusted to adjust the detection range of the sensor.

In the sensor bracket according to the present disclosure, the sensor may be a camera or a radar and may be attached to the sensor fixing portion so as to have an optical axis direction of a lens or an emitting direction of radio waves that is orthogonal to an extending direction of the integral hinge portion.

Thus, a camera or a radar can be used as the sensor.

In the sensor bracket according to the present disclosure, the rib plate is attached to the engagement claw.

Thus, the detection direction of the sensor can be easily adjusted.

A sensor attachment method, comprising: preparing a sensor bracket composed of a resin member in which a sensor fixing portion to which a sensor is fixed, a base portion capable of internally housing the sensor, and an integral hinge portion which connects the base portion and the sensor fixing portion and enables rotation of the sensor fixing portion relative to the base portion; fixing the sensor to the sensor fixing portion so as to have a detection direction of the sensor that is orthogonal to an extending direction of the integral hinge portion; rotating the sensor fixing portion around the integral hinge portion to house the sensor within the base portion and engaging an engagement claw provided at a tip of the sensor fixing portion into an engagement hole formed in the base portion, to mount the sensor fixing portion to the base portion; fastening an upper region of the base portion to a lower region of a body; and, adjusting a thickness of a rib plate disposed between a circumferential edge of the engagement hole in the base portion and the engagement claw to adjust a detection range of the sensor.

Thus, the detection range of the sensor can be adjusted by adjusting the detection direction of the sensor fixed to the sensor fixing portion even after the sensor is attached to the body.

The present disclosure can provide a sensor bracket capable of adjusting a detection range of a sensor after the sensor is attached to a body.

### BRIEF DESCRIPTION OF DRAWINGS

FIG. 1 is an elevation view of a sensor bracket according to an embodiment;

FIG. 2 is a cross-sectional view of the sensor bracket according to the embodiment taken along line A-A of FIG. 1;

FIG. 3 is an explanatory view showing a method of attaching the sensor to the body using the sensor bracket of the embodiment, and is a view showing a fixing step of fixing the sensor to the sensor bracket;

FIG. 4 is an explanatory view showing a method of attaching a sensor to a body using the sensor bracket of the embodiment, and is an explanatory view showing an assembling step of assembling a sensor fixing portion to a base portion and a fastening step of fastening an upper end of the base portion to a lower portion of the body;

FIG. 5 is a detailed view of a part B shown in FIG. 4.

FIG. 6 is an explanatory view showing a method of attaching the sensor to the body using the sensor bracket of the embodiment, and is an explanatory view showing an adjustment step;

FIG. 7 is a detailed view of a part C shown in FIG. 6.

### DESCRIPTION OF EMBODIMENTS

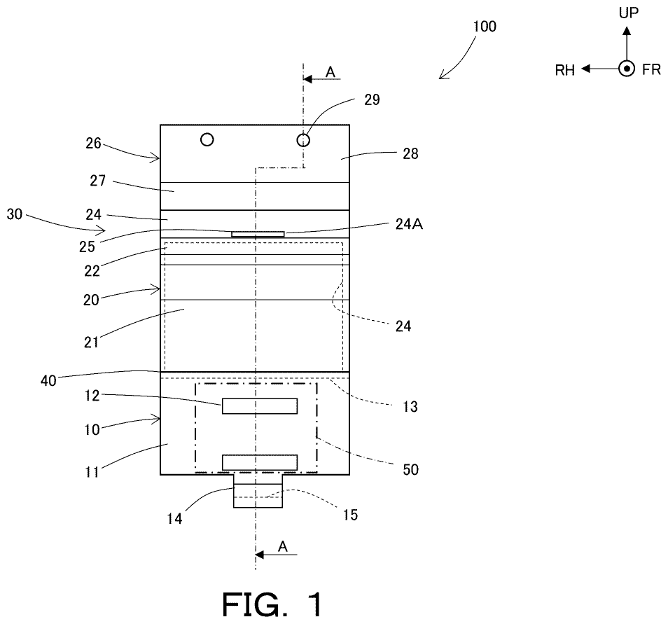

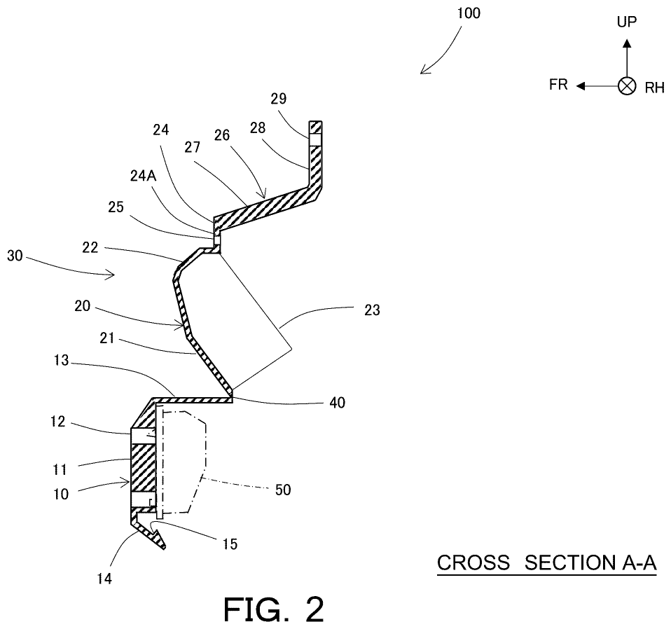

Hereinafter, a sensor bracket 100 according to an embodiment will be described with reference to the drawings. As shown in FIGS. 1 and 2, the sensor bracket 100 includes a sensor fixing portion 10, a base portion 30, and an integral hinge portion 40. The sensor bracket 100 is a resin member in which the sensor fixing portion 10, the base portion 30, and the integral hinge portion 40 are integrally molded.

The sensor bracket 100 is a resin component. The sensor 50 is fixed to the sensor fixing portion 10, and the sensor fixing portion 10 is rotated around the integral hinge portion 40 to assemble the sensor fixing portion 10 to the base portion 30. When the upper portion of the base portion 30 is fastened to the body 45 of the vehicle, the sensor 50 is attached to the body 45. FIGS. 1 and 2 show the sensor bracket 100 before the sensor fixing portion 10 is assembled to the base portion 30.

As shown in FIGS. 1 and 2, the base portion 30 includes a cover portion 20 and an arm portion 26. The cover portion 20 includes a front plate 21, left and right side plates 23, an upper plate 22, and an upper flange 24. The front plate 21 and the left and right side plates 23 constitute a groove-shaped cross-sectional portion. The upper plate 22 covers the upper end portion of the groove-shaped cross-sectional portion. The upper flange 24 is a plate member extending upward from the rear end of the upper plate 22. The upper flange 24 is provided with a square engagement hole 25.

The arm portion 26 includes a main body 27 and a mounting flange 28. The main body 27 is a plate member extending obliquely rearward and upward from the upper flange 24 of the cover portion 20. The mounting flange 28 is a plate member extending upward from the upper end of the main body 27. Two bolt holes 29 are provided in an upper portion of the mounting flange 28.

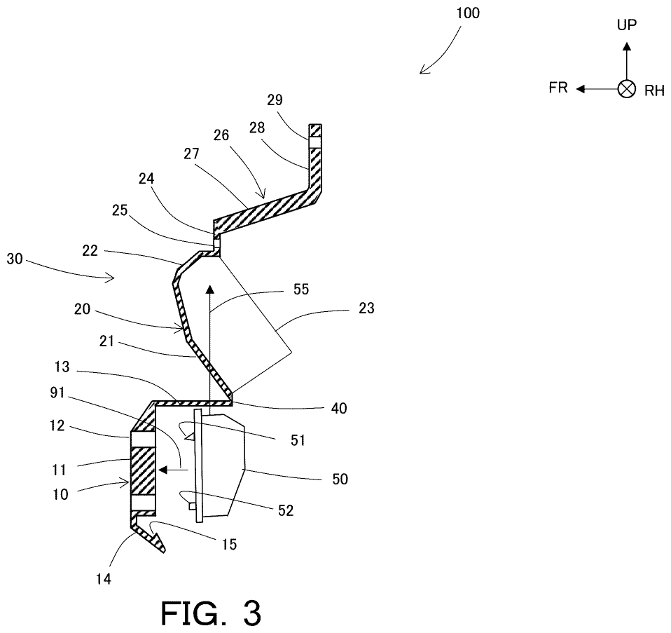

The sensor fixing portion 10 is a portion connected to the lower side of the cover portion 20 via the integral hinge portion 40. The sensor fixing portion 10 includes a sensor holding plate 11, a connecting plate 13, and an engagement arm 14. The sensor holding plate 11 is a plate member to which the sensor 50 is fixed. The sensor holding plate 11 is provided with two mounting holes 12 into which mounting legs 51 and 52 (see FIG. 3) of the sensor 50 are fitted. The connecting plate 13 is a plate member that connects the upper end of the sensor holding plate 11 and the integral hinge portion 40. In the open state shown in FIGS. 1 and 2, the connecting plate 13 extends forward from the integral hinge portion 40. The engagement arm 14 is a plate member extending obliquely downward and rearward from the lower end of the sensor holding plate 11. An engagement claw 15 is provided at a distal end portion of the engagement arm 14.

The integral hinge portion 40 is a linear portion extending in the left-right direction between the cover portion 20 of the base portion 30 and the sensor fixing portion 10. The integral hinge portion 40 is thinner than the cover portion 20 and the sensor fixing portion 10, and connects the base portion 30 and the sensor fixing portion 10 so that the sensor fixing portion 10 is rotatable with respect to the base portion 30. The integral hinge portion 40 may be, for example, a valley line of a V-shaped groove extending in the left-right direction along a boundary line between the cover portion 20 and the sensor fixing portion 10.

The sensor fixing portion 10, the base portion 30, and the integral hinge portion 40 described above are formed by integral molding of resin.

Next, a method of attaching the sensor 50 to the body 45 of the vehicle using the sensor bracket 100 will be described with reference to FIGS. 3 to 7. First, the sensor bracket 100 and the sensor 50 are prepared (preparation step).

First, as indicated by an arrow 91 in FIG. 3, the mounting legs 51 and 52 of the sensor 50 are inserted into the mounting hole 12 of the sensor holding plate 11. Thus, the sensor 50 is fixed to the sensor holding plate 11 (fixing step). At this time, the sensor 50 is fixed to the sensor holding plate 11 so that the detection direction 55 is an upward direction. The upward direction is a direction orthogonal to the left-right direction in which the integral hinge portion 40 extends. Here, when the sensor 50 is a camera, the detection direction 55 is the optical axis direction of the lens. When the sensor 50 is a radar, the detection direction 55 is an irradiation direction of radio waves.

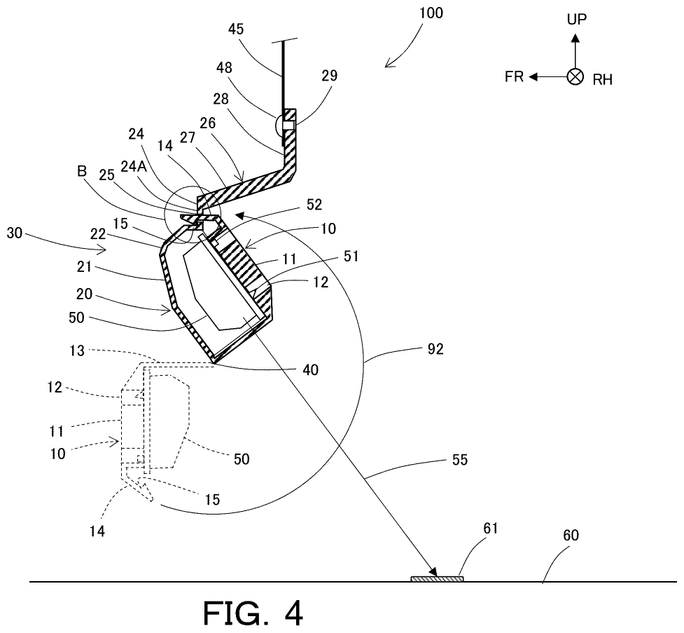

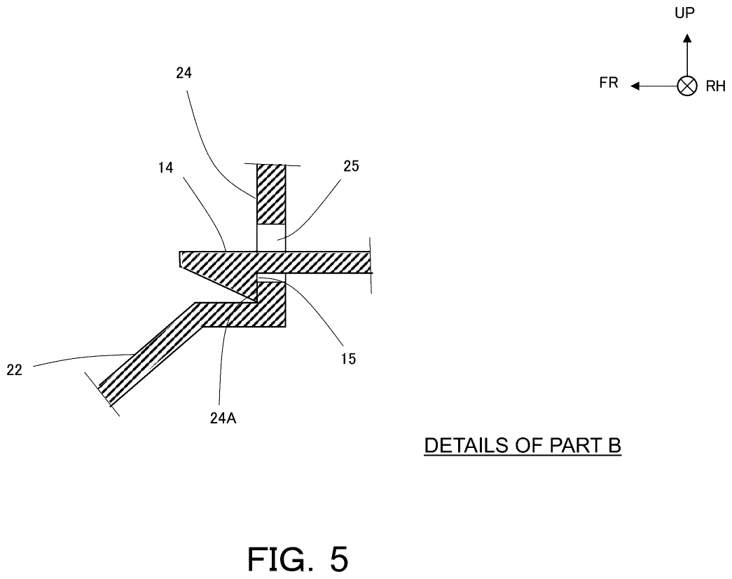

Next, as shown in FIG. 4, the sensor fixing portion 10 is rotated around the integral hinge portion 40. Then, the engagement arm 14 provided in the sensor fixing portion 10 is inserted into the engagement hole 25 provided in the base portion 30. When the tapered portion of the tip of the engagement claw 15 passes through the engagement hole 25, the engagement arm 14 bends upward, but when the engagement claw 15 passes through the engagement hole 25, the engagement arm 14 returns downward. As a result, as shown in FIG. 5, the engagement claw 15 of the engagement arm 14 engages with the peripheral edge 24A of the engagement hole 25. Thus, the sensor fixing portion 10 is assembled to the base portion 30 (assembly step).

As shown in FIG. 4, when the sensor fixing portion 10 is assembled to the base portion 30, the sensor 50 is accommodated in the cover portion 20. Here, the cover portion 20 includes an upper plate 22 of the base portion 30, a front plate 21, and left and right side plates 23. Thus, the upper side, the front side, and the left and right side surfaces of the sensor 50 are covered with the upper plate 22, the front plate 21, and the left and right side plates 23. The rear side of the sensor 50 is covered with a sensor holding plate 11. The lower side of the sensor 50 is covered with a connecting plate 13. As a result, it is possible to prevent foreign matters such as pebbles from hitting the sensor 50.

When the sensor fixing portion 10 is assembled to the base portion 30, the bolt hole 29 of the mounting flange 28 of the arm portion 26 is fitted to a bolt hole (not shown) provided in the body 45. Then, the mounting flange 28 is fastened to the lower portion of the body 45 by bolt 48 (fastening step). Thus, the sensor 50 is attached to the body 45.

When the sensor 50 is attached to the body 45, a detection direction 55 of the sensor 50 with respect to the ground 60 is defined as shown in FIG. 4. At the same time, a detection range 61 of the sensor 50 on the ground 60 is defined. At this time, when the detection range 61 of the sensor 50 deviates from the design detection range, the adjustment process described below is performed.

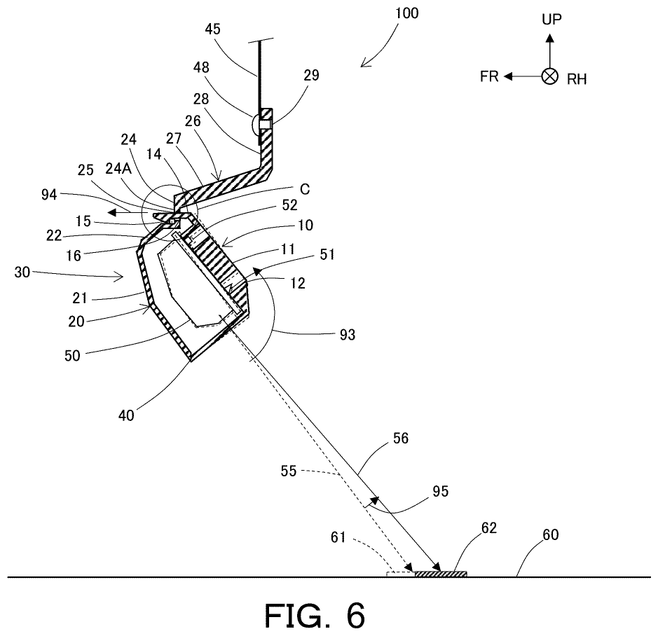

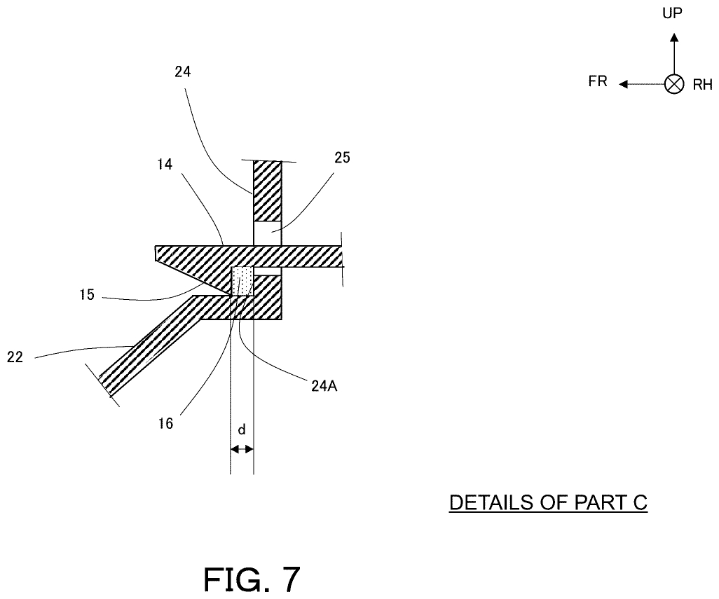

The sensor fixing portion 10 is rotated around the integral hinge portion 40 as indicated by an arrow 93 in FIG. 6, and the engagement arm 14 is moved in the forward direction as indicated by an arrow 94 in FIG. 6. Then, as shown in FIG. 7, a rib plate 16 having a thickness d is attached between the engagement claw 15 and the peripheral edge 24A of the engagement hole 25. As a result, the assembly angle of the sensor fixing portion 10 with respect to the base portion 30 and the assembly angle of the sensor fixing portion 10 with respect to the ground 60 change. Since the detection direction 55 of the sensor 50 is orthogonal to the extending direction of the integral hinge portion 40, when the sensor fixing portion 10 is rotated around the integral hinge portion 40, the detection direction 55 moves to the correction detection direction 56 as indicated by an arrow 95 in FIG. 6. As a result, the position of the detection range 61 of the ground 60 moves to the correction detection range 62. When the rib plate 16 is fixed, the correction detection direction 56 and the correction detection range 62 are defined. Here, the moving distance of the detection range 61 can be adjusted by adjusting the thickness d of the rib plate 16.

As described above, when the sensor 50 is attached to the body 45 using the sensor bracket 100 of the embodiment, the position of the detection range 61 can be adjusted after the sensor 50 is attached to the body 45.

Further, since the detection direction 55 of the sensor 50 can be adjusted after the sensor 50 is attached to the body 45, a camera or a radar can be adopted as the sensor 50.

Further, since the sensor bracket 100 can be formed by integral molding of resin, the number of components can be reduced.

In the above description, the mounting flange 28 is fastened to the body 45 after the sensor fixing portion 10 is assembled to the base portion 30. However, the present disclosure is not limited to this step. The sensor fixing portion 10 may be assembled to the base portion 30 after the mounting flange 28 is fastened to the body 45.

In the above description, the rib plate 16 is set by further pushing the engagement arm 14 after the engagement arm 14 is engaged with the engagement hole 25. However, the present disclosure is not limited to this step. For example, the sensor fixing portion 10 may be assembled to the base portion 30 in a state in which the rib plate 16 is set on the engagement claw 15 of the engagement arm 14. Thereafter, the detection direction 55 may be adjusted by sandwiching the additional rib plate between the additional rib plate and the peripheral edge 24A of the engagement hole 25.

Further, the rib plate 16 may be formed of a tapered plate, and the distance between the engagement claw 15 and the peripheral edge 24A of the engagement hole 25 may be adjusted depending on the sandwiching position.

In the above description, the cover portion 20 of the base portion 30 is configured to accommodate the sensor 50 inside the front plate 21, the left and right side plates 23, and the upper plate 22. However, the base portion 30 is not limited to this shape as long as the sensor 50 can be accommodated therein.

1. A sensor bracket, comprising:
a sensor fixing portion to which a sensor is fixed;
a base portion capable of internally housing the sensor; and
an integral hinge portion that connects the base portion and the sensor fixing portion and enables rotation of the sensor fixing portion with respect to the base portion, wherein
the sensor fixing portion includes, at a tip end thereof, an engagement claw;
the base portion includes an engagement hole in which the engagement claw is engaged,
the sensor fixing portion, the base portion, and the integral hinge portion are integrally formed by molding resin, when the sensor fixing portion rotates around the integral hinge portion, the sensor is housed within the base portion, and the engagement claw is engaged in the engagement hole, to mount the sensor fixing portion to the base portion, and
a rib plate is disposed between a circumferential edge of the engagement hole of the base portion and the engagement claw, the rib plate having an adjustable thickness.

2. The sensor bracket according to claim 1, wherein
the sensor is attached to the sensor fixing portion so as to have a detection direction orthogonal to an extending direction of the integral hinge portion.

3. The sensor bracket according to claim 1, wherein
the sensor is a camera or a radar and is attached to the sensor fixing portion so as to have an optical axis direction of a lens or an emitting direction of radio waves that is orthogonal to an extending direction of the integral hinge portion.

4. The sensor bracket according to claim 1, wherein
the rib plate is attached to the engagement claw.

5. The sensor bracket according to claim 2, wherein
the rib plate is attached to the engagement claw.

6. The sensor bracket according to claim 3, wherein
the rib plate is attached to the engagement claw.

7. A sensor attachment method, comprising:
preparing a sensor bracket composed of a resin member in which a sensor fixing portion to which a sensor is fixed, a base portion capable of internally housing the sensor, and an integral hinge portion which connects the base portion and the sensor fixing portion and enables rotation of the sensor fixing portion relative to the base portion;
fixing the sensor to the sensor fixing portion so as to have a detection direction of the sensor that is orthogonal to an extending direction of the integral hinge portion;
rotating the sensor fixing portion around the integral hinge portion to house the sensor within the base portion and engaging an engagement claw provided at a tip of the sensor fixing portion into an engagement hole formed in the base portion, to mount the sensor fixing portion to the base portion;
fastening an upper region of the base portion to a lower region of a body; and,
adjusting a thickness of a rib plate disposed between a circumferential edge of the engagement hole in the base portion and the engagement claw to adjust a detection range of the sensor.
